(19) United States
(12) Patent Application Publication
(10) Pub. No.: US 2007/0300169 A1
(43) Pub. Date: Dec. 27, 2007

(54) METHOD AND SYSTEM FOR FLAGGING CONTENT IN A CHAT SESSION AND PROVIDING ENHANCEMENTS IN A TRANSCRIPT WINDOW

(76) Inventors: Doris L. Jones, Somerville, MA (US); Corinne M. Ryan, Westford, MA (US)

Correspondence Address: LOTUS AND RATIONAL SOFTWARE;McGuinness & Manaras LLP, 125 NAGOG PARK, ACTON, MA, 01720, US

(21) Appl. No.: 11/426,334

(22) Filed: Jun. 26, 2006

(51) Int. Cl. G06F 3/00

(52) U.S. Cl. 715/764; 715/758

(57) ABSTRACT

A system for flagging content in a chat session and providing enhancements in a transcript window. The system allows a user to set visible flags at the starting pointing of lines in the transcript area of the live chat window. Once one or more visual flags has been set in the transcript area, they are visually displayed in the transcript area visually indicating the lines they are associated with, and the live chat window is further modified to enable the user to navigate to the flags. When a flag is set, it is also added to a visually displayed list of such flags. The visually displayed flag list allows the user to select a flag and quickly navigate to a particular area within the chat transcript area that the user has deemed to be relatively significant. The flag list may be displayed at the top of the chat transcript within the transcript area itself, as a horizontal list of hot links, or in a new display region added to the live chat window, or in some other way. A “Next Flag” graphical button or the like may be displayed that allows the user to click on it to navigate to a next flag within the transcript area. When a chat transcript is saved, for example to a file or in an email document, the transcript area flags are saved, for example as HTML anchors.

### FIELD OF THE INVENTION

The present invention relates generally to user interfaces for instant messaging systems, and more specifically to a method and system for flagging content in a chat session and providing enhancements in a transcript window.

### BACKGROUND OF THE INVENTION

As it is generally known, in computer-based communications, instant messaging systems enable instant communications between two or more people over a communication network such as the Internet. Instant messaging typically requires the use of a client program to provide an instant messaging service. Instant messaging differs from electronic mail (“email”) in that conversations happen in real-time. Instant messaging sessions are sometimes referred to as “chat” sessions. Examples of existing instant messaging technologies include Qnext, MSN Messenger, AOL Instant Messenger, Yahoo! Messenger, Skype, Google Talk, .NET Messenger Service, Jabber, QQ, iChat and ICQ, and Internet Relay Chat (IRC).

In conventional instant messaging applications, a user first initiates a chat session with at least one chat partner. After the session is initiated, information is passed back and forth between the session participants, and is displayed in a transcript area of the application user interface. Some of the information displayed in the transcript display area is relatively important, while other information is less important. For example, instructions being conveyed regarding a development project, such as instructions regarding the setup of a software build, might be considered relatively more important to a chat participant than other information displayed in the transcript area. However, in spite of the differences of importance between specific pieces of displayed information, all information in the display area is scrolled out of sight as new information is entered. In the case of a long chat session, a user may have to perform the tedious task of scrolling or paging upward in the chat window to find the important information. This can be almost impossible if the chat partner is still actively adding messages into the transcript area. Another option is to save the entire chat transcript to a file, or directly into the body of an email message. But here again the user is faced with time consuming steps. First, the user must navigate to the location of the chat transcript (e.g. within the file system or email application). Next the user must somehow sift through the entire chat transcript. To avoid these time consuming and inconvenient actions, it would be desirable to have an easier method to quickly access important information obtained during a chat session, either during a live chat or within a saved chat transcript.

Accordingly, for the above set forth reasons and others, it would be desirable to have a new system for flagging content in a chat session and providing enhancements in a transcript window.

### SUMMARY OF THE INVENTION

In order to address the above described and other shortcomings of previous systems, a new method and system are disclosed for flagging content in a chat session and providing enhancements in a transcript window. The disclosed system allows a user to set visible flags at the starting point of lines in the live chat. Once one or more visual flags has been set, they are displayed indicating the lines of the chat session they are associated with, and the live chat window is further modified to enable the user to navigate to the flags.

When a flag is set, it may also be added to a displayed list links to flags. The user can subsequently click on specific links within the list to be relocated to positions within the chat session at which the corresponding flags were set. Thus the visually displayed link list allows the user to select a flag and quickly navigate to a particular area within the chat session that the user has deemed to be relatively significant. The flag link list may be displayed at the top of the chat transcript within the transcript area itself, as a horizontal list of links, in a new display region added to the live chat window, or in some other way. Alternatively, or in addition, a “Next Flag” graphical button or the like may be displayed that allows the user to click on it to navigate to a next flag within the chat session.

When a chat session transcript is saved, for example to a file or in an email document, the flags that were set during the session are also saved. For example, each flag may be represented in the form an HTML (HyperText Mark-up Language) anchor, thus allowing flags to be visually displayed when the transcript is subsequently displayed through a rich text viewer program or the like.

Thus there is disclosed a new system for flagging content in a chat session and providing enhancements in a transcript window. The disclosed system advantageously provides users with a way to flag important content within a live chat session, such that they can conveniently navigate to the flagged content even after the important content has been moved out of the current transcript area. The disclosed system further eliminates the need to scroll through a live chat session to find important content that has been moved out of the current transcript area, or to save a chat session transcript for the purpose of finding important information. Additionally, the disclosed system provides for saving flags in a chat session into a transcript file, such that they can be conveniently accessed when the transcript file is later accessed through a rich text viewer program or the like.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram showing components in an execution environment including an illustrative embodiment of the disclosed system;

FIG. 2 is a simplified screen shot showing an instant messaging user interface window;

FIG. 3 is a simplified screen shot showing an instant messaging user interface window and one technique for selecting a line of content within a transcript display area at which to locate a visible flag as provided by an illustrative embodiment of the disclosed system;

FIG. 4 is a simplified screen shot showing an instant messaging user interface window and a visible flag displayed within a transcript display area;

FIG. 5 is a simplified screen shot showing an instant messaging user interface window and one example of a flag navigation user interface mechanism provided by an illustrative embodiment of the disclosed system;

FIG. 6 is a simplified screen shot showing an instant messaging user interface window having multiple visible flags provided by an illustrative embodiment of the disclosed system;

FIG. 7 is a simplified screen shot showing an instant messaging user interface window having a horizontal list of hot links displayed at the beginning of a chat session to enable navigation to specific flag locations;

FIG. 8 is a simplified screen shot showing an instant messaging user interface window having a vertical list of hot links displayed at the side of a chat session transcript display area to enable navigation to specific flag locations;

FIG. 9 is a simplified screen shot showing a rich text viewer user interface window having a horizontal list of hot links displayed at the beginning of a chat session to enable navigation to specific flag locations; and

FIG. 10 is a flow chart showing steps performed during operation of an illustrative embodiment.

### DETAILED DESCRIPTION OF EXEMPLARY EMBODIMENTS

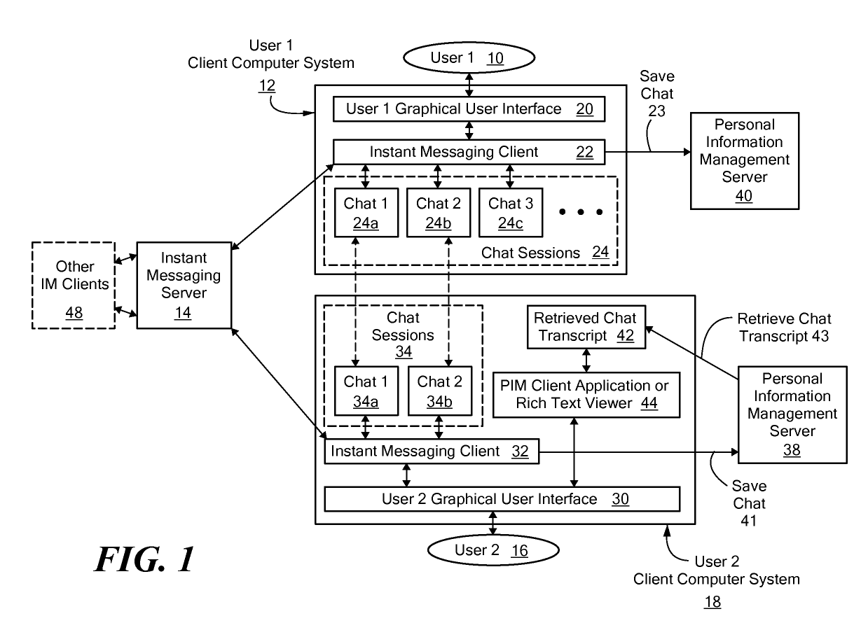

FIG. 1 is a block diagram showing components in an execution environment including an illustrative embodiment of the disclosed system. As shown in FIG. 1, a User 1 10 uses a User 1 Client Computer System 12 to perform instant messaging through an Instant Messaging Server 14 with a number of other users, including a User 2 16 that uses a User 2 Client Computer System 18. Each line of text typed during an instant messaging session between User 1 10 and User 2 16 passes through the Instant Messaging Server 14. The Instant Messaging Server 14 further enables instant messaging to be performed with Other Instant Messaging Clients 48. The User 1 Client Computer System 12 is shown including a User 1 Graphical User Interface 20 provided at least in part by an Instant Messaging Client application program 22. The Instant Messaging Client 22 displays a number of Chat Sessions 24 to the User 1 10 through the User 1 Graphical User Interface 20, shown for purposes of illustration including Chat 1 24a, Chat 2 24b, Chat 3 24c, etc.

The User 2 Client Computer System 18 is shown including an Instant Messaging Client application program 32 that provides, at least in part, a User 2 Graphical User Interface 30. The Instant Messaging Client 32 displays a number of Chat Sessions 34 to User 2 16, shown for purposes of illustration including a Chat 1 34a and a Chat 2 34b. In the example of FIG. 1, Chat 1 34a corresponds to Chat 1 24a in the User 1 Client Computer System 12, and Chat 1 34a and Chat 1 24a together represent a chat session between User 1 10 and User 2 16. Similarly, Chat 2 34b may correspond to Chat 2 24b in the User 1 Client Computer System 12, and Chat 2 34b and Chat 2 24b together represent another chat session between User 1 10 and User 2 16.

A Personal Information Management Server 40 is also shown in FIG. 1 as an example of a repository for persistent storage of chat session transcripts for chat sessions of User 1 10. For example, the Instant Messaging Client 22 may operate to save 23 a chat session to the Personal Information Management Server 40. Similarly, Personal Information Management Server 38 is also shown in FIG. 1 as an example of a persistent storage repository for chat session transcripts for chat sessions of User 2 16. As show for purposes of illustration in FIG. 1, the Instant Messaging Client 32 may save 41 a chat session to the Personal Information Management Server 38. Saved chat transcripts may include all the content of a live chat session in a file or other type of document. Saving of a chat transcript may, for example, be performed by client software in response to a user indication received through a user interface provided by a chat application client program.

After a chat session transcript has been saved, it can subsequently be re-opened for viewing. For example, as shown for purposes of illustration in FIG. 1, a Retrieved Chat Transcript 42 may be retrieved 43 by a Personal Information Management Client or Rich Text Viewer application program 44 from the Personal Information Management Server 38. The Retrieved Chat Transcript 42 has thus been read back into the User 2 Client Computer System 18, and is being presented within the User 2 Graphical User Interface 30 by the Personal Information Management Client or Rich Text Viewer application program 44. The Personal Information Management Client or Rich Text Viewer program 44 may be any specific type of program that is operable to display Rich Text format content or the like.

The client computer systems 12 and 18, and server computer systems 14, 38 and 40 of FIG. 1 are communicably connected, for example by way of a communication network such as the Internet, a Local Area Network (LAN), or other specific type of communication network. The client software 22 and 32 may, for example, use a client-server approach to operating with server application software executing on the server computer system 14 to provide portions of the graphical user interfaces 20 and 30. Alternatively, the client software 22 and 32 may include Web browser program functionality operable to request and receive Web page content, including HTML (Hypertext Markup Language) code or the like, from the Instant Messaging Server 14, and to render such Web page content in their respective user interfaces.

The client computer systems 12 and 18, and the server computer systems 14, 38 and 40, may each include at least one processor, program storage, such as memory, for storing program code executable on the processor, and one or more input/output devices and/or interfaces, such as data communication and/or peripheral devices and/or interfaces. The client computer systems 12 and 18, and the server computer systems 14, 38 and 40, may each further include appropriate operating system software.

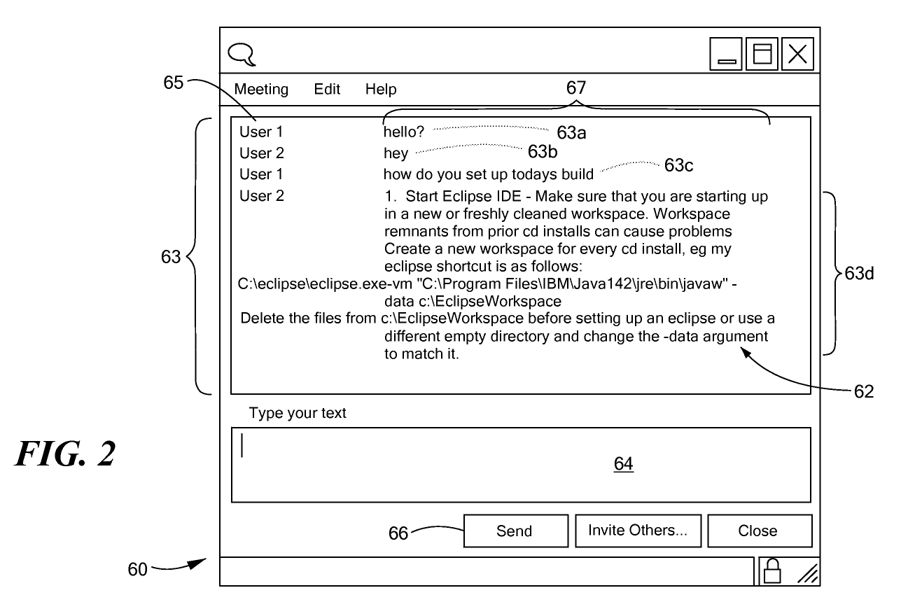

FIG. 2 is a simplified screen shot showing an Instant Messaging User Interface Window 60. The instant messaging user interface window 60 may, for example, be provided to User 1 10 of FIG. 1 by the Instant Messaging Client 22 through the User 1 Graphical User Interface 20. The Instant Messaging User Interface Window 60 is shown including a Transcript Display Area 62, displaying a Chat Session 63 between User 1 10 and User 2 16 (FIG. 1). The Chat Session 63 is made up of a number of lines (also known as “messages”), including a line 63a entered by User 1 10 and consisting of the text “hello?”, followed by line 63b entered by User 2 16 consisting of the text “hey”, followed by line 63c made up of the text “how do you set up todays build”, followed by line 63d beginning with the text “1. Start Eclipse IDE”, and so on. Each line in the Chat Session 63 is formatted into a first part 65 indicating the user that entered the line, and a second part 67 containing the line contents. Lines are entered into the Chat Session 63 by typing or otherwise entering content into the content entry area 64, and then clicking on the Send button 66.

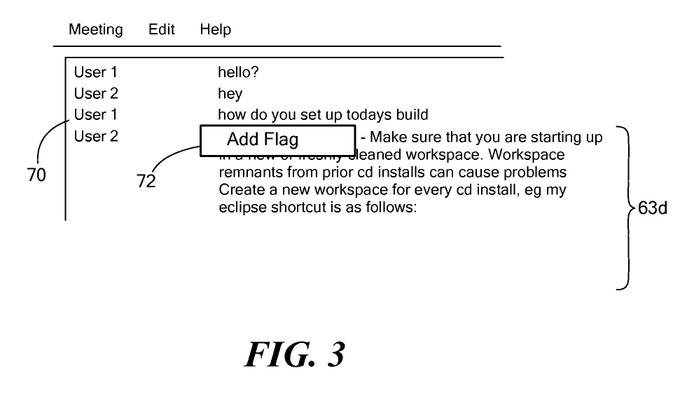

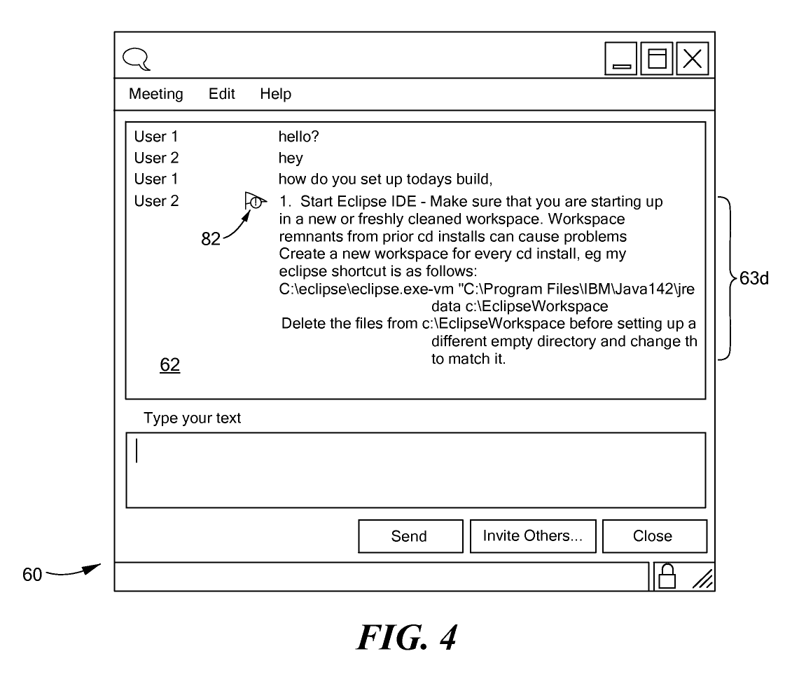

FIG. 3 is a simplified screen shot showing a portion 70 of the Instant Messaging User Interface Window 60 of FIG. 1. FIG. 3 illustrates one technique for selecting a line of content within a transcript display area at which to locate a visible flag in an illustrative embodiment of the disclosed system. In the example of FIG. 3, User 1 10 has decided that line 63d includes important information. Accordingly, User 1 10 decides to flag line 63d so that it can be conveniently navigated to even after it has been scrolled out of the transcript display area. User 1 10 therefore performs an action to flag line 63d with a visible flag that will cause line 63d to be easily navigated to with the disclosed system. In the exemplary embodiment of FIG. 3, User 1 10 moves the cursor over line 63d, and then performs a right click operation, for example using a mouse or other specific type of computer input device. As a result of the right click operation, a menu option 72 is displayed to the user. If User 1 10 clicks on or otherwise selects the menu option 72 when the cursor is located over line 63d, then the disclosed system operates to add a visible flag to line 63d, as illustrated in FIG. 4. The menu option 72 is an example of a context sensitive menu (or “context menu”), sometimes referred to as a “right click” menu, and is shown only for purposes of illustrating one possible embodiment of the disclosed system. Those skilled in the art will recognize that other specific types of menus may be used in the alternative to provide the functionality described herein purely for purposes of explanation in connection with the illustrative menu option 72.

FIG. 4 is a simplified screen shot showing Instant Messaging User Interface Window 60 with a Visible Flag 82 displayed within Transcript Display Area 62. The Visible Flag 82 visually indicates line 63d. Any specific shape or location may be used in embodiments of the disclosed system in order to provide a visible flag that visually indicates a line of a chat session. Accordingly, while the Visible Flag 82 includes flag and exclamation mark shapes, other shapes may be used in alternative embodiments. Moreover, while the Visible Flag 82 is located over one specific part of the line 63d, it may be located in any other specific position that would cause it to visually indicate line 63d.

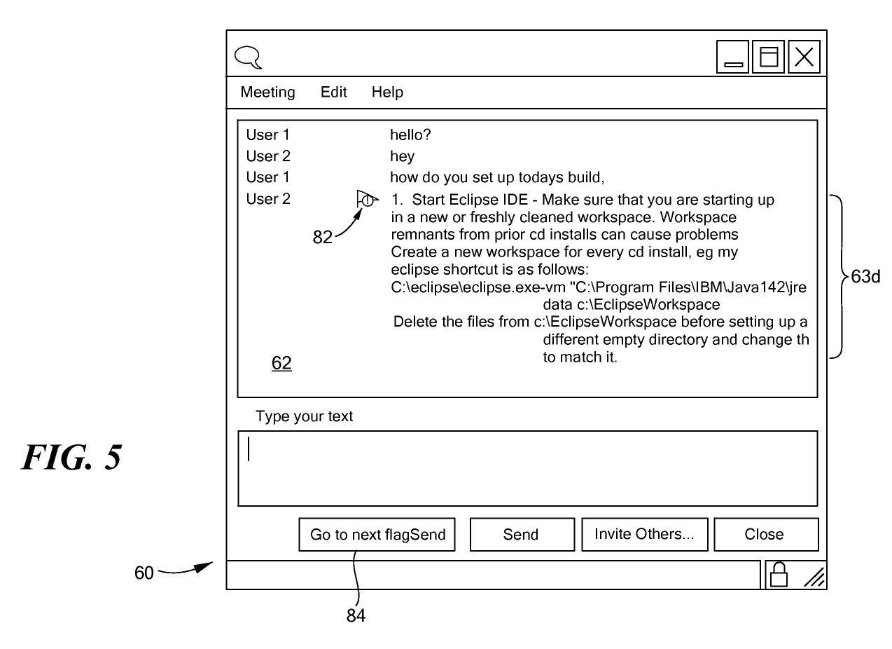

FIG. 5 is a simplified screen shot showing Instant Messaging User Interface Window 60 including an example of a flag navigation user interface mechanism provided by an illustrative embodiment of the disclosed system. As shown in FIG. 5, one example of a flag navigation user interface mechanism is a Next Flag button 84. When a user selects the Next Flag button 84, for example by clicking on it with a mouse or other computer input device, the disclosed system operates to move the contents of the current chat session within the Transcript Display Area 62 such that the line indicated by the next following visible flag in the current chat session is displayed within the Transcript Display Area 62. Accordingly, if the next following flag in the chat session currently being displayed in the Transcript Display Area 62 indicates a line within the chat session that has previously been scrolled out of or otherwise become not currently visible within the Transcript Display Area 62 when the Next Flag button is clicked on, then the chat session contents currently displayed within the Transcript Display Area 62 are changed such that the line indicated by the next following visible flag is currently displayed within the Transcript Display Area 62 in response to the user clicking on the Next Flag button 84. For example, if the line 63d had been recently scrolled out of the Transcript Display Area 62, and then User 1 10 clicked on the Next Flag button 84, and assuming that the Visible Flag 82 was the next following visible flag in the current chat session displayed in the Transcript Display Area 62, then the portion of the current chat session displayed in the Transcript Display Area 62 would be changed such that line 63 and Visible Flag 82 were displayed within the Transcript Display Area 62, as shown in FIG. 5.

The disclosed system may further be embodied to additionally provide a “Previous Flag” button that operates in the same manner as the Next Flag button 84, albeit that enables the user to directly navigate to a next previous visible flag within the current chat session displayed in the Transcript Display Area 62. Such a “Previous Flag” button may, for example, be provided at the same time as the Next Flag button 84.

In one embodiment of the disclosed system, the Next Flag button 84 is generated and displayed in response to the User 1 10 setting a first visible flag. Alternatively, the Next Flag button 84 may be generated in response to a user setting a second visible flag, or may be provided at all times, even if no visible flags have been set, or may be generated in response to some other trigger condition.

While a graphical button is shown for purposes of illustration in FIG. 5 as an example of a graphical user interface mechanism for allowing navigation between visible flags in a chat session, other specific graphical user interface mechanisms, such as pull down menus, scroll bars, etc., may be used alternatively as may be appropriate for a given embodiment.

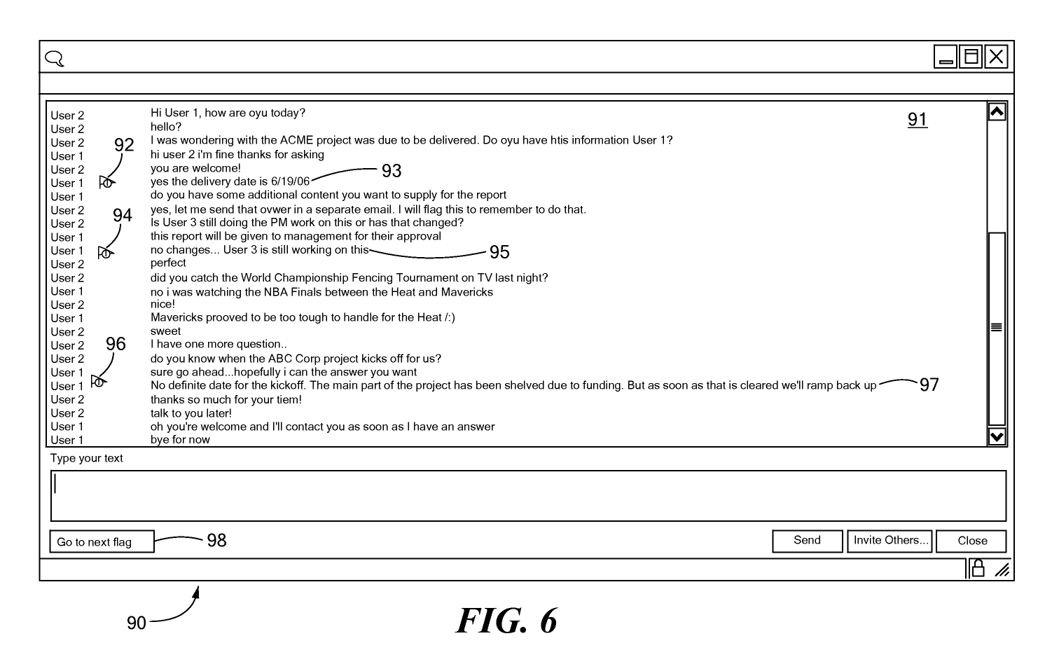

FIG. 6 is a simplified screen shot showing an Instant Messaging User Interface Window 90 having multiple visible flags provided by an illustrative embodiment of the disclosed system. For example, the Instant Messaging User Interface Window 90 may be generated and displayed to the User 1 10 of FIG. 1 by the Instant Messaging Client application program 22. The Instant Messaging User Interface Window 90 is shown including a Transcript Display Area 91, in which three visible flags have been set. A first Visible Flag 92 visually indicates line 93 of the current chat session displayed in the Transcript Display Area 91, a second Visible Flag 94 visually indicates a line 95 of the current chat session, and a third Visible Flag 96 visually indicates a line 97 in the current chat session. The Next Flag button 98 enables the User 1 10 to navigate between visible flags that may have been scrolled out of the Transcript Display Area 91, such as would be the case if Visible Flag 92, Visible Flag 94, and/or Visible Flag 96 were subsequently scrolled out of the Transcript Display Area 91, for example as a result of new content being added by the participating users in the current chat session being displayed in the Transcript Display Area 91.

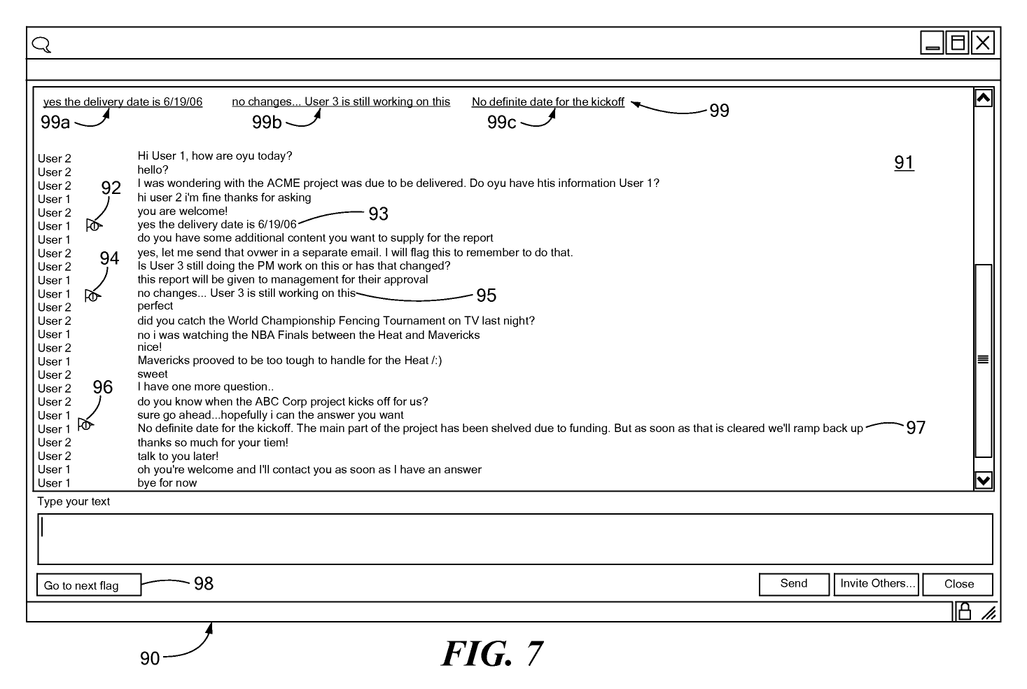

FIG. 7 is a simplified screen shot showing an alternative embodiment of the Instant Messaging User Interface 90, in which a horizontal Hot Link List 99 is displayed at the beginning of a chat session to enable navigation to specific visible flag locations within a current chat session being displayed in the Transcript Display Area 91. In the embodiment of the disclosed system shown in FIG. 7, the Hot Link List 99 is shown for purposes of explanation including a first Hot Link 99a corresponding to the Visible Flag 92, a second Hot Link 99b corresponding to the Visible Flag 94, and a third Hot Link 99c corresponding to the Hot Link 99c. Each of the hot links in the Hot Link List 99 enables the User 1 10 to navigate directly to the corresponding one of the visible flags in the currently displayed chat session by simply clicking on the link using a mouse computer interface device or the like, or by otherwise selecting the hot link. For example, if the user clicks on the Hot Link 99a, then the currently displayed chat session in the Transcript Display Area 91 is shifted so that the Visible Flag 92 and the line within the chat session that is visually indicated by the Visible Flag 92 are shown in the Transcript Display Area 91. Similarly, clicking on the Hot Link 99b causes the Visible Flag 94 and the line of the chat session it indicates to be moved into the Transcript Display Area 91, and clicking on the Hot Link 99c causes the Visible Flag 96 and the line of the chat session it indicates to be moved into the Transcript Display Area 91. The visible flag and the line of content within the chat session that is visually indicated by the visible flag are moved into the Transcript Display Area 91 in response to the user clicking on the corresponding one of the hot links in the Hot Link List 99 even after that visible flag and that line of the chat session have been scrolled out of the Transcript Display Area 91.

Each time the User 1 10 sets a new visible flag within the current chat session in the Transcript Display Area 91, a new corresponding hot link is added to the Hot Link List 99. The format of the individual hot links in the Hot Link List 99 is shown as including the first several characters or words within the line of the chat session visually indicated by the corresponding visible flag, but other specific formats may be used alternatively as may be appropriate for a given embodiment.

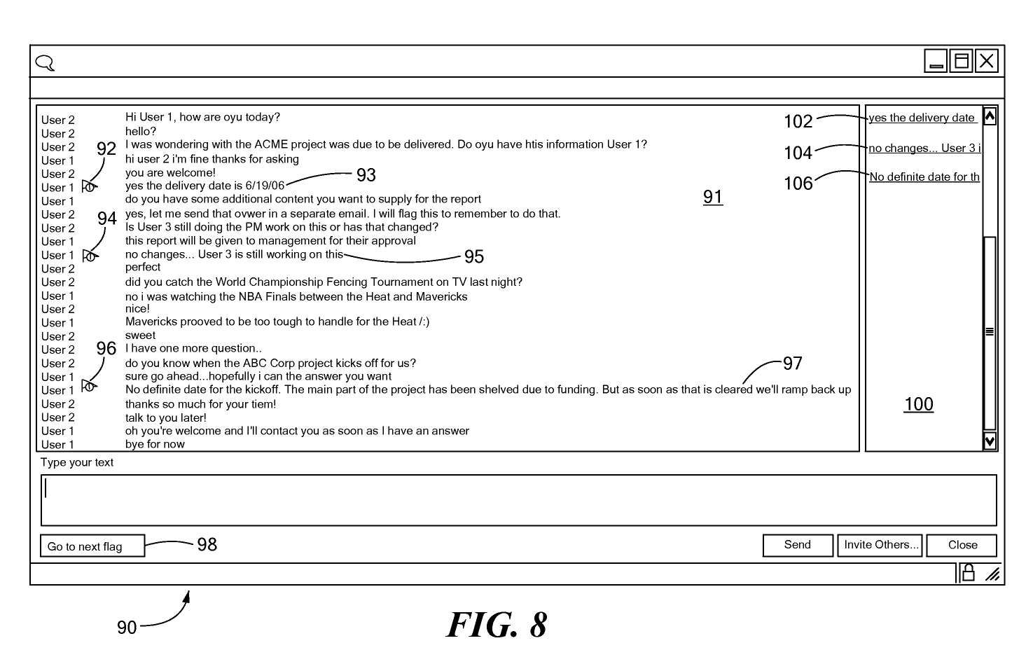

FIG. 8 is a simplified screen shot showing another alternative embodiment of the Instant Messaging User Interface Window 90 having a vertical Hot Link List 100 of hot links 102, 104 and 106 displayed at the side of the chat session Transcript Display Area 91 as an alternative to the horizontal Hot Link List 99 shown in FIG. 7. The vertical Hot Link List 100 includes hot links that enable the User 1 10 to navigate to locations of corresponding visible flags and the lines of the chat session displayed in the Transcript Display Area 91. Specifically, clicking on or otherwise selecting the Hot Link 102 causes the Visible Flag 92 and the line 93 to be brought into the Transcript Display Area 91, clicking on or otherwise selecting the Hot Link 104 causes the Visible Flag 94 and the line 95 to be brought into the Transcript Display Area 91, and clicking on or otherwise selecting Hot Link 106 causes the Visible Flag 96 and the line 97 to be brought into the Transcript Display Area 91. A visible flag corresponding to one of the hot links in the Hot Link List 100 and the line indicated by that hot link are brought into the Transcript Display Area 91 even in the case where that visible flag and indicated line have been previously scrolled out of the Transcript Display Area 91. The format of the hot links in the Hot Link List 100 may include the first few words or characters of the line of chat session indicated by corresponding visible flag, or some other format may be used. As in the example of FIG. 7, hot links are added to the Hot Link List 100 as new visible flags are added to lines within the chat session currently being displayed in the Transcript Display Area 91. Clicking on the Next Flag button causes the next visible flag and line of chat content that it indicates to be brought into the Transcript Display Area 91.

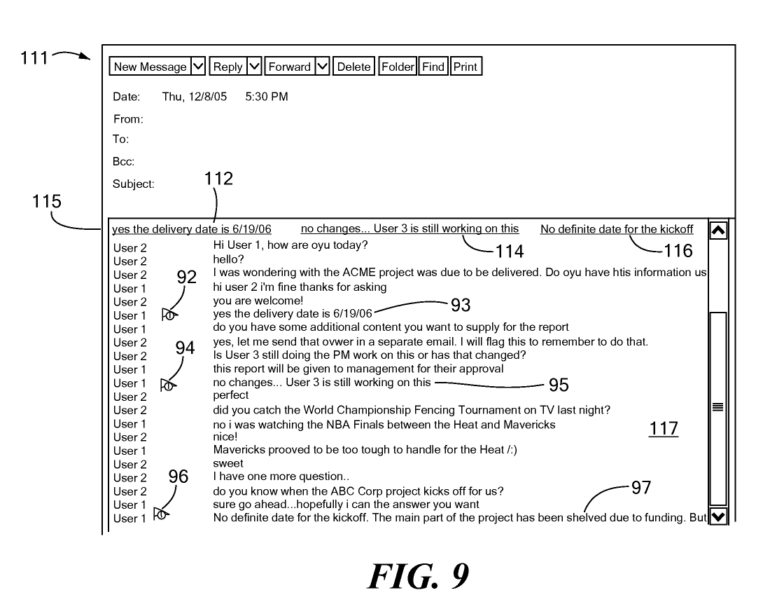

FIG. 9 is a simplified screen shot showing a Rich Text Viewer User Interface Window 111, including a having a horizontal Hot Link List 115 the beginning of a chat session to enable navigation to specific flag locations within a Transcript Display Area 117. The Rich Text Viewer User Interface Window 111 may, for example, be generated by the Personal Information Management Client or Rich Text Viewer application 44 as part of the User 2 Graphical User Interface 30 to present a previously saved chat session, such as the Retrieved Chat Transcript 42, for User 2 16, as shown in FIG. 1. In the example of FIG. 9, the Hot Link List 116 includes hot links 112, 114 and 116 that represent each visible flag that was set during the chat session stored in the Retrieved Chat Transcript 42. The hot links 112, 114 and 116 are examples of menu items that were inserted at the beginning of the Retrieved Chat Transcript 42 at the time it was saved. The links in the Hot Link List 115 again each include some number of words from the line of the chat session visually indicated by the corresponding visible flag. Accordingly, Hot Link 112 includes the first few words of line 93, since it corresponds to Visible Flag 92, Hot Link 114 includes the first few words of line 95, since it corresponds to Visible Flag 94, and Hot Link 116 includes the first few lines of line 97, since it corresponds to Visible Flag 96. Clicking on any of the hot links in the Hot Link List 115 causes the corresponding visible flag and the line of chat that it indicates to be moved into the Transcript Display Area 117. In this way, the hot links in the Hot Link List 115 link to anchors that were set by the user during the chat session that was saved into the Retrieved Chat Transcript 42.

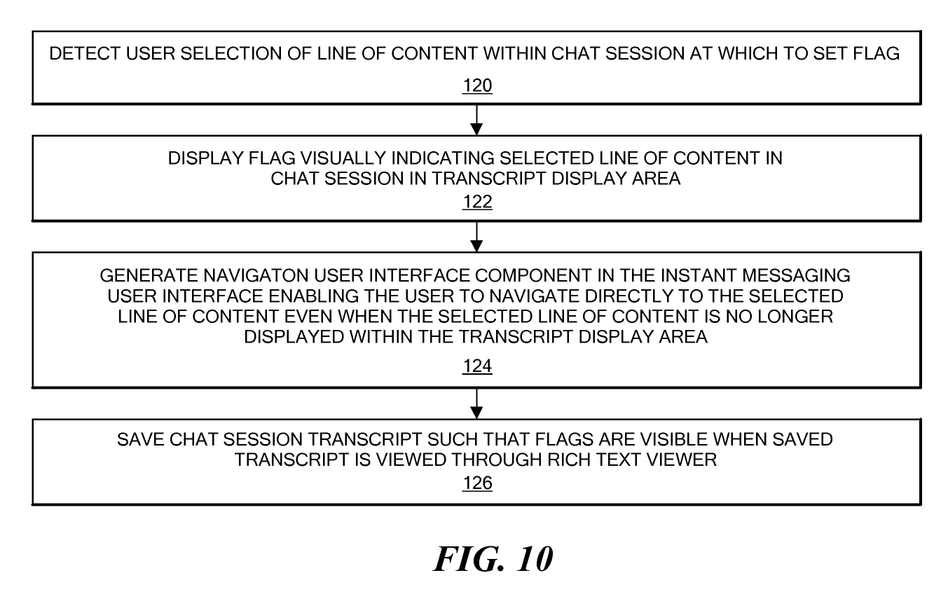

FIG. 10 is a flow chart showing steps performed during operation of an illustrative embodiment. At step 120, the disclosed system detects a user selection of a line of content within a chat session at which a visible flag is to be set.

At step 122, the disclosed system displays a flag visually indicating the line of content selected at step 120 within the transcript display area of the instant messaging user interface window.

At step 124, the disclosed system generates a navigation user interface component in the instant messaging user interface window that enables the user to navigate directly to the selected line of chat content indicated by the previously set flag even after that line of content has been scrolled out of the current contents of the transcript display area within the instant messaging user interface window.

At step 126, the disclosed system operates to save the chat session transcript for the chat session in which were set a number of visible flags, such that the flags will be made visible and navigable when the saved chat transcript is viewed using a rich text viewer application program or the like. In one embodiment, each visible flag is inserted into the chat transcript as an HTML anchor, which is a destination of a Web hyperlink, and is specified by the <a> HTML element. A hyperlink for each such HTML anchor is stored within the saved chat transcript, for example as a corresponding hot link stored at the beginning of the saved chat transcript. The anchor element may be generated when the flag is initially positioned by the user, for example at step 120 or step 122.

The disclosed system can take the form of an entirely software embodiment, an entirely hardware embodiment, or an embodiment containing both software and hardware elements. The figures include block diagram and flowchart illustrations of methods, apparatus(s) and computer program products according to an embodiment of the invention. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed.

We claim:

1. A method of flagging content in a chat session, comprising:
inserting, in response to user selection of a line of content within a transcript display area of an instant messaging user interface, a visible flag located in said transcript display area and visually indicating said line of content within said chat session; and
generating, in response to said setting of said visible flag, a navigation user interface component within said instant messaging user interface, wherein said navigation user interface component enables a user to navigate directly to said line of content when said line of content is no longer displayed within said transcript display area.

2. The method of claim 1, wherein said navigation user interface component enables said user to navigate directly to said line of content in said transcript display area when said line of content is no longer displayed within said transcript display area by clicking on said navigation user interface component.

3. The method of claim 2, wherein said navigation user interface component comprises a next flag graphical button that, when clicked on, causes navigation to a line of content associated with a next visible flag in said chat session.

4. The method of claim 2, wherein said navigation user interface component comprises a list of hot links, each of said hot links corresponding to one of a plurality of visible flags previously set in said chat session, wherein clicking on one of said hot links causes navigation to a line of content visually indicating a corresponding one of said plurality of visible flags.

5. The method of claim 4, wherein said list of hot links comprises a horizontal list located at a beginning of said chat session.

6. The method of claim 4, wherein said list of hot links comprises a vertical list displayed visually indicating said transcript display area.

7. The method of claim 2, further comprising:
responsive to a save operation on said chat session, representing each visible flag in said chat session in a saved representation of said chat session.

8. The method of claim 7, wherein said representing each visible flag in said chat session comprises representing each visible flag with a corresponding mark up language anchor element.

9. A system including a computer readable medium, said computer readable medium having program code stored thereon for flagging content in a chat session, said program code comprising:
program code for inserting, in response to user selection of a line of content within a transcript display area of an instant messaging user interface, a visible flag located in said transcript display area and visually indicating said line of content within said chat session; and
program code for generating, in response to said setting of said visible flag, a navigation user interface component within said instant messaging user interface, wherein said navigation user interface component enables a user to navigate directly to said line of content when said line of content is no longer displayed within said transcript display area.

10. The system of claim 9, wherein said navigation user interface component enables said user to navigate directly to said line of content in said transcript display area when said line of content is no longer displayed within said transcript display area by clicking on said navigation user interface component.

11. The system of claim 10, wherein said navigation user interface component comprises a next flag graphical button that, when clicked on, causes navigation to a line of content associated with a next visible flag in said chat session.

12. The system of claim 10, wherein said navigation user interface component comprises a list of hot links, each of said hot links corresponding to one of a plurality of visible flags previously set in said chat session, wherein clicking on one of said hot links causes navigation to a line of content visually indicating a corresponding one of said plurality of visible flags.

13. The system of claim 12, wherein said list of hot links comprises a horizontal list located at a beginning of said chat session.

14. The system of claim 12, wherein said list of hot links comprises a vertical list displayed visually indicating said transcript display area.

15. The system of claim 10, said program code further comprising:
program code for, responsive to a save operation on said chat session, representing each visible flag in said chat session in a saved representation of said chat session.

16. The system of claim 15, wherein said program code for representing each visible flag in said chat session comprises program code for representing each visible flag with a corresponding mark up language anchor element.

17. A computer program product including a computer readable medium, said computer readable medium having program code stored thereon for flagging content in a chat session, said program code comprising:
program code for inserting, in response to user selection of a line of content within a transcript display area of an instant messaging user interface, a visible flag located in said transcript display area and visually indicating said line of content within said chat session; and
program code for generating, in response to said setting of said visible flag, a navigation user interface component within said instant messaging user interface, wherein said navigation user interface component enables a user to navigate directly to said line of content when said line of content is no longer displayed within said transcript display area.

18. A computer data signal embodied in a carrier wave, said computer data signal having program code stored thereon for flagging content in a chat session, said program code comprising:
program code for inserting, in response to user selection of a line of content within a transcript display area of an instant messaging user interface, a visible flag located in said transcript display area and visually indicating said line of content within said chat session; and
program code for generating, in response to said setting of said visible flag, a navigation user interface component within said instant messaging user interface, wherein said navigation user interface component enables a user to navigate directly to said line of content when said line of content is no longer displayed within said transcript display area.

19. A system for flagging content in a chat session, comprising:
means for displaying, in response to user selection of a line of content within a transcript display area of an instant messaging user interface, a visible flag located in said transcript display area and visually indicating said line of content within said chat session; and
means for generating, in response to said setting of said visible flag, a navigation user interface component within said instant messaging user interface, wherein said navigation user interface component enables a user to navigate directly to said line of content when said line of content is no longer displayed within said transcript display area.
